(19) United States
(12) Patent Application Publication
(10) Pub. No.: US 2009/0047461 A1
(43) Pub. Date: Feb. 19, 2009

(54) Ticket Device

(75) Inventor: Joakim Sporrong, Goteborg (SE)

Correspondence Address: POTOMAC PATENT GROUP PLLC, P. O. BOX 270, FREDERICKSBURG, VA, 22404, US

(73) Assignee: Q-MATIC AB, Molndal (SE)

(21) Appl. No.: 12/160,759

(22) PCT Filed: Jan. 4, 2007
(86) PCT No.: PCT/SE07/50002

§ 371 Date: Sep. 28, 2008

(30) Foreign Application Priority Data
Jan. 13, 2006 (SE) 0600067-3

(51) Int. Cl. G09F 3/00

(52) U.S. Cl. 428/43

(57) ABSTRACT

The present invention relates to a continuous web (1) consisting of a thin material, for instance paper, divided by a plurality of separation areas (3). Said separation areas (3) constitute delimitations between tickets (2) and are positioned at a distance from each other in the longitudinal direction (y) of the web and extend in the cross direction (x) between the edges (7) of the web and consist of a number of separate slot sections (4, 5) essentially extending in the cross direction (x). The invention is substantially characterized in that the slot sections (4, 5) are situated at a distance in the longitudinal direction (y) in relation to adjacent slot sections (4, 5) within the same separation area (3) so that adjacent tickets (2), before tearing off, are held together by material areas (6) situated between adjacent slot sections (4, 5). Said holding together is effected in such a way that the areas (6) between adjacent slot sections (4, 5) are arranged to, upon the tearing off, substantially be subjected to a shear stress when a force is applied in essentially the longitudinal direction (y).

### TECHNICAL FIELD

The present invention relates to a continuous web consisting of a thin material, for instance paper, divided by a plurality of separation areas, which constitute delimitations between tickets, and which are positioned at a distance from each other in the longitudinal direction of the web and extend in the cross direction between the edges of the web and consist of a number of separate slot sections essentially extending in the cross direction.

### PRIOR ART

A plurality of different solutions regarding the look of the perforation of tickets, queue tickets, etc., exist. The most common one consists of a straight perforation in the cross direction in relation to the main extension direction of the paper (the longitudinal direction). The perforation consists of a number of slots having intermediate attachment points or of a large number of holes located close to each other. However, said perforation has a tendency to become a bit difficult to tear off since sufficiently enough uniting material has to be present in order for the tickets not to be separated already during the manufacture or upon the feed of tickets inside the ticket machine.

A problem with the straight perforation is also that the force required for tearing off tickets or the like varies considerably. The optimal method upon tearing off is to tear off one attachment point at a time, in such cases only a force sufficient for separating one attachment point is needed to tear off the entire ticket. In such cases, the tearing off is commenced from one of the edges, and when one attachment point has been broken, the tearing off is completed without problems transverse to the width of the perforation. However, problems arise when a ticket taker tries tearing off a ticket by gripping a central portion of the ticket and pull this straight out in the longitudinal direction. Since the force required for tearing off the ticket is given by the formula F=σ·A·n, where σ is the tensile stress of the material, A is the area of each attachment point and n is the number of attachment points, the force required for tearing off the ticket in this example will be n times larger than when tearing off one attachment point at a time. This imposes high requirements on the brake mechanism in the ticket machines, which have to be able to absorb large forces. If too large a force is applied, it may also happen that ticket perforations inside the machine break, and therefore the feed of new tickets will not work.

U.S. Pat. No. 5,294,034 shows, as an example, a queue-ticket roll in which the queue tickets are held together by two aligned perforation sections located close by the respective edge, as well as an additional attaching part positioned at a longitudinal distance from these and halfway between the edges. Between said three attaching parts, essentially longitudinal slots are found. It is true that this design of the holding together of the queue tickets makes it fairly simple to tear off tickets, since there is not so much material holding the tickets together. However, it provides the queue tickets an impractical shape, which is not desired as it makes it difficult to print information on the queue tickets.

U.S. Pat. No. 6,696,127 shows a sequence of paper tickets separated by perforations. The amount of paper holding together the different pieces of paper is larger at the edges of the perforation than at the centre thereof, which entails that the force required for tearing off a ticket by grasping a centred hold of the ticket becomes considerably smaller than in an even distribution of the attachment points, according to the above, at the same time as the force required for tearing off one attachment point at a time laterally increases. It is true that this perforation solves a part of the problems with previously known perforations, but yet has some of the problems associated with previously known perforations.

Recently, it has become more and more common with ticket machines having built-in automatic ticket separators, which cut off a piece of the ticket roll corresponding to the size of a ticket, after which the ticket can be removed from the machine without any tear-off measure being required by the person removing the ticket. However, said ticket machines become mechanically complex, which may cause future repairs, and entails also a greater initial cost for the person acquiring the machine.

However, today there is no known perforation that works optimally and that, before tearing off, reliably holds together the tickets, and that upon tearing off, easily and almost without resistance allows different tickets to be separated manually.

### SUMMARY OF THE INVENTION

In the previously known ticket tear-off technique, the perforations are formed so that the tickets should be possible to be torn off in the easiest way using as small a force as possible. If the force is applied in the longitudinal direction of the ticket web, the perforation is subjected to a tensile stress. If the force is applied from the side of the ticket, i.e., if a person about to tear off a ticket applies a larger force in one of the cross directions than in the other at the same time as a certain force is applied in the longitudinal direction, the perforation will be subjected to a combined tensile and shear stress. This provides a more efficient tearing off at the same time as the attachment points of the perforated portion affected simultaneously are fewer upon the lateral application.

Usually, paper is an anisotropic material, which means that it has different properties in different directions. This implies that paper can carry different large forces in different directions, which depends on how the fibres included in the paper are oriented. In the manufacture of long paper webs, the paper fibres have a tendency to become oriented in the machine direction, i.e., in the longitudinal direction of a ticket web or the like. This means that the web can carry a larger tensile stress in the longitudinal direction of the web than in the cross direction. However, the opposite applies to shear stresses. The web can only carry a relatively low shear stress in the longitudinal direction.

Thus, the object of the present invention is to provide a perforation at a web of tickets, queue tickets, etc., which solves the problems mentioned above and which ensures that tickets, etc., essentially are separated thanks to shear stress or a combination of tensile and shear stress, irrespective of where on the ticket the tear-off force is applied, and in particular presents a simple tearing off when the tear-off force is applied halfway between the edges of the ticket.

Said object is attained by means of a web that has the features defined in the independent claims.

Additional embodiments of the invention are defined in the appurtenant dependent claims.

### BRIEF DESCRIPTION OF THE DRAWINGS

In the following, the invention will be described in a non-limiting way and for illustrative purposes, reference being made to accompanying figures, wherein:

FIG. 1 shows a detailed view of a separation area between two tickets according to a preferred embodiment of the present invention;

FIG. 2 shows a number of tickets held together by separation areas according to a preferred embodiment of the present invention;

FIG. 3 shows a detailed view of a separation area between two tickets according to an alternative embodiment of the present invention;

FIG. 4 shows a detailed view of a separation area between two tickets according to yet an alternative embodiment of the present invention;

FIG. 5 shows a detailed view of a separation area between two tickets according to an additional alternative embodiment of the present invention;

FIG. 6 shows also a detailed view of a separation area between two tickets according to an alternative embodiment of the present invention;

FIG. 7 shows a detailed view of a separation area between two tickets according to an alternative embodiment of the present invention;

FIG. 8 shows a detailed view of a separation area between two tickets where the tickets have been separated according to one embodiment of the present invention;

FIG. 9 shows a detailed view of a separation area between two tickets according to another embodiment of the present invention;

FIG. 10 shows an enlarged view of the look of a torn-off area of a ticket according to one embodiment of the present invention;

FIG. 11 shows a detailed view of a separation area between two tickets according to an additional embodiment of the present invention; and

FIG. 12 shows finally a detailed view of a separation area between two tickets according to an additional embodiment of the present invention.

### DETAILED DESCRIPTION OF THE INVENTION

FIG. 1 shows a detailed view of a separation area 3 between two tickets 2 according to a preferred embodiment of the present invention. A web 1 for tickets, queue tickets, etc., consists of an elongate strip of paper or any other similar material, where adjacent tickets, queue tickets, etc., are separated by separation areas 3. Said separation areas 3 are there to assist in the separation of two adjacent tickets 2 and are evenly positioned in the longitudinal direction y of the web. A separation area 3 has the main extension thereof in the cross direction x between the edges 7 of the web, and consists of a number of separate slot sections 4, 5 essentially extending in the cross direction x. According to this embodiment, the separation area 3 consists of two parallel rows 8A, 8B in which the slot sections 4, 5 are arranged. Preferably, the slot sections 4, 5 extend perpendicularly in relation to the extension direction y of the web 1, and every second slot section 4 is situated on one of the rows 8B and every second slot section 5 is situated on the other row BA.

The web has to be composed of a thin material and examples of feasible materials that the web could be composed of are paper, tissue, non-woven, carton, foil, plastic, fabric as well as laminate or different combinations of said materials. However, the present invention relates essentially to paper.

The total length of all slot sections 4, 5 is approximately the same as the distance between the edges 7. The ends 5A, 5B of the slot sections 5 that are positioned in one 8A of the parallel rows 8A, 8B begin and end on essentially the same cross-direction positions as the corresponding nearest ends 4B, 4A of the slot sections 4 in the other 8B of said rows end and begin. The ends 4A, 5A situated to the left in the figure designates the beginning of the slot sections 4, 5 and the ends 4B, 5B situated to the right in the figure the ending thereof.

Thus, what holds together the two tickets 2 is only the longitudinal sections 6 situated between the ends 4A-5B, 4B-5A of the adjacent slot sections 4, 5 arranged on different rows 8A, 8B. A slot section 4, 5 could be composed of a plurality of aligned, slotted portions separated by paper, and thereby also these paper portions assist in providing the holding together. However, this is not desirable since it makes the separation more difficult and is neither necessary.

With the adjacent slot sections is simply meant the slot sections that are located closest to each other, irrespective of in which direction they are at a distance from each other. Since the tickets 2 are held together by the areas 6 between adjacent slot sections 4, 5, it is these areas 6 that will break when a tear-off force is applied to a ticket 2, irrespective of in which direction the force is applied. However, usually a customer or some one tearing off a ticket wants to apply the tear-off force in essentially the longitudinal direction y. In this embodiment, the paper area 6 holding together the tickets will in general only be subjected to a shear stress, which will result in a simple and efficient tearing off. In the longitudinal direction, paper is namely less resistant to shear stress than to tensile stress, which makes that the total length of the uniting area can be made greater if the area only will carry shear stress, but still be torn off equally easy as with previous perforation designs. This makes that the tickets 2 either can be held together harder in the manufacture and in the ticket machine, etc., but still be torn off equally easy as, or easier than, previous solutions, or that the same can be torn off easier but still be held together equally hard or harder. Upon separation, the uniting area will be “torn” off instead of be “pulled” in two as previously.

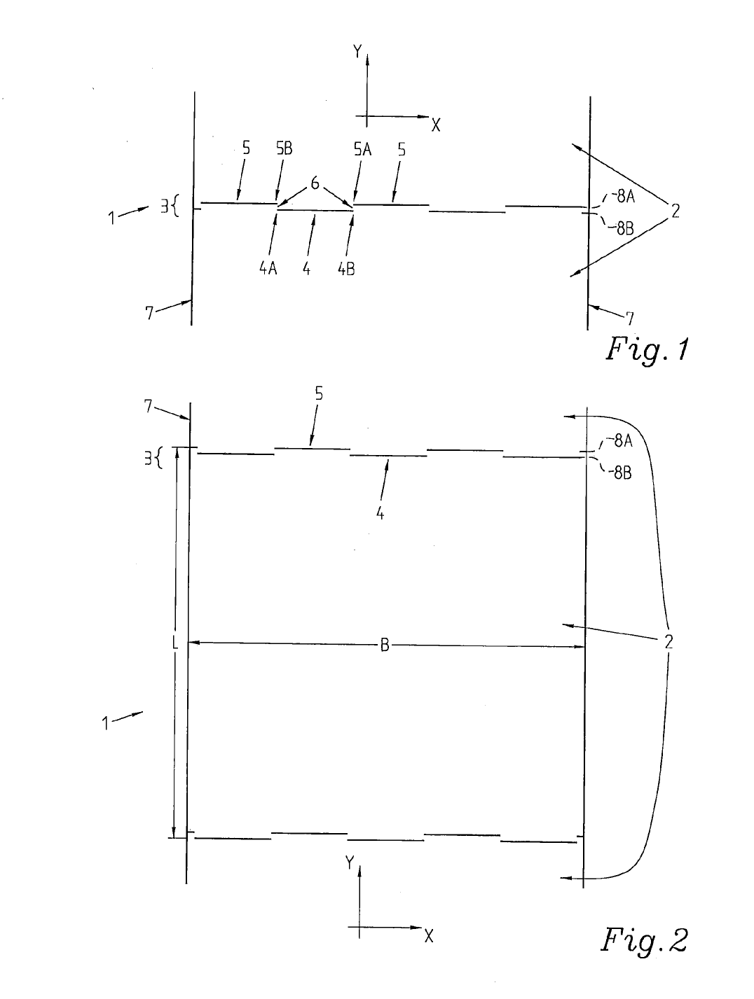

FIG. 2 shows a number of tickets that have separation areas 3 between the tickets 2 according to FIG. 1. In this example, the total width B of the separation area 3 is 60 mm, and the distance between the separation areas 3 is equal, and thereby the length L of the tickets also amounts to 60 mm. The five large slot sections are 11.6 mm long, and close by the edges there are two slot sections, which each is 1 mm long. The longitudinal distance between adjacent slot sections 4, 5 and thereby between the different rows 8A, 8B is 1 mm. The length of the slot sections may naturally vary, but they should preferably be within the interval of 5-15 mm, except the slot portions located closest to the edges 7. The longitudinal distance between adjacent slot sections may also vary, but is preferably within the interval of 0.5-3 mm.

With tickets, reference is made to tickets and queue tickets intended to be separated manually in the longitudinal direction from adjacent tickets and queue tickets. Tickets may also relate to coupons or bills to be torn off from adjacent papers or, alternatively, sheets of paper joined via a perforation. But primarily, technical applications of queue tickets are intended.

The tickets are preferably arranged to be rolled up on a roll. However, another accumulation may also be found, such as, for example, accumulation in a coil shape, bundles, etc.

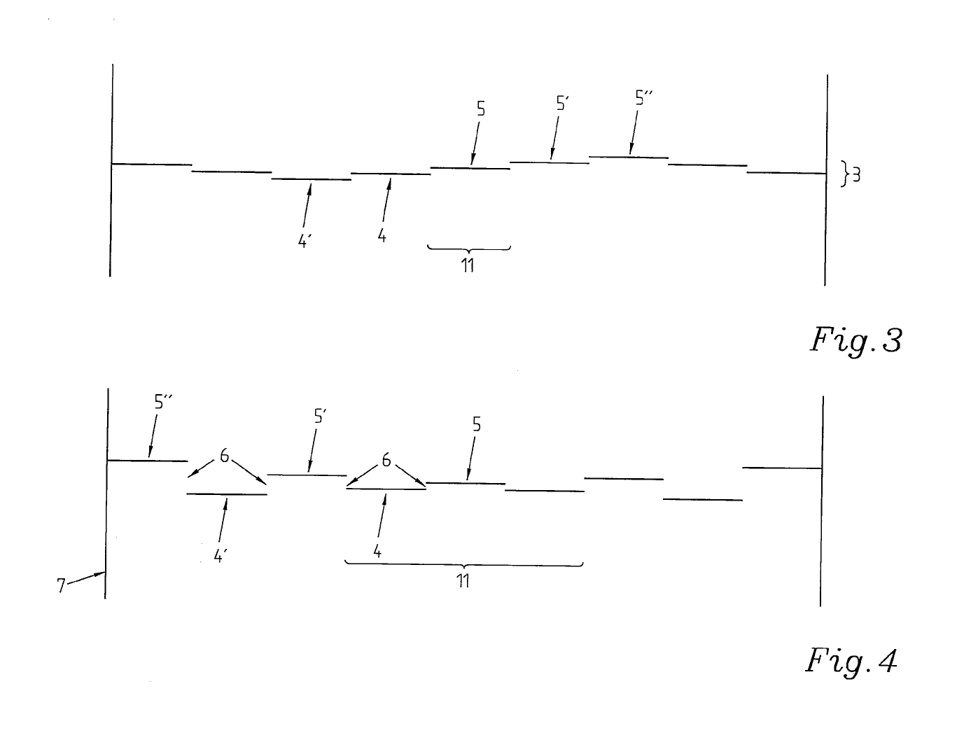

FIG. 3 shows a detailed view of a separation area 3 between two tickets 2 according to an alternative embodiment of the present invention. In this example, the slot sections 4, 4′, 5, 5′ and 5″ are arranged on several different longitudinal positions. Here, slot section 5 designates the section located centrally in the longitudinal direction. The slot sections 4 and 4′ designate the slot sections situated underneath the section 5 located centrally in the longitudinal direction, and the sections located above said section 5 are designated 5′ and 5″. This embodiment is an example of a separation area that is asymmetrical.

FIG. 4 shows a detailed view of a separation area 3 between two tickets 2 according to yet an alternative embodiment of the pre-sent invention. The longitudinal distance between adjacent slot sections 4, 4′, 5, 5′ and 5″ is smaller in a central portion 11 of said separation area than at the edges 7 thereof. In this embodiment, this means that the slot sections 4, 5 positioned in the central portion 11 have a longitudinal distance to each other that is considerably smaller than the longitudinal distance between slot sections 4′, 5″ positioned near an edge 7. This entails that a somewhat different tearing-off procedure will take place when the tickets are to be separated. A person about to tear off a ticket who applies a force in a central portion 11 of the ticket will bring about that adjacent tickets first are separated in the central portion 11 in order to subsequently progress the separation procedure out toward the edges 7, where the uniting areas 6 are larger than in the central portion. This will lead to a combined tensile and shear stress, which essentially will affect one area 6 at a time, and therefore the requisite force for separating the areas 6 is relatively small. However, in the central portion 11, the area 6 will in general only be subjected to a shear stress. The central portion 11 is preferably larger than at least two uniting material areas 6.

A similar effect would be achieved if the slot sections of the central portion were made longer than the slot sections at the edges, even if the longitudinal distance between the slot sections is equally great. In such a manner, the total amount of continuous material 6 would be less in the central portion than at the edges 7, since the number of continuous areas would be greater at the edges 7.

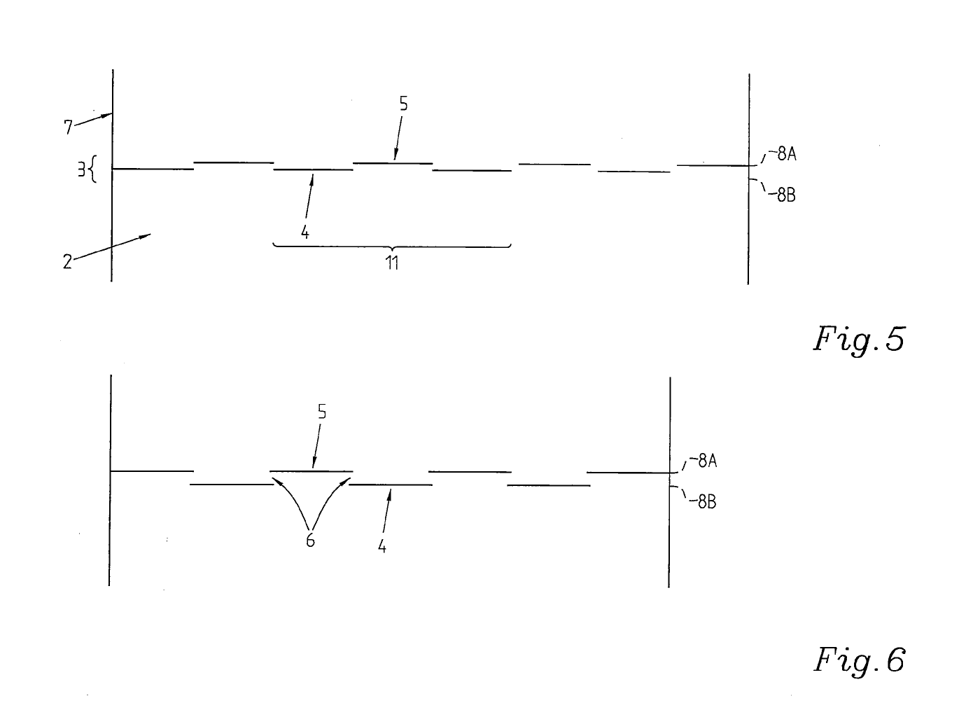

FIG. 5 shows a detailed view of an alternative design of a separation area 3 between two tickets 2. In this example, the length of the slot sections 4, 5 is differently long within the separation area 3. The slot sections 4, 5 are situated on different rows 8A, 8B, so that the longitudinal distance is essentially the same between the slot sections 4, 5, irrespective of the position along the separation area 3. In this example, the separation area 3 is asymmetrical and weaker on one of the sides (the left one), which provides an easier tearing off when the ticket 2 is torn off from the left to the right.

FIG. 6 also shows a detailed view of a separation area between two tickets according to an alternative embodiment of the present invention. Here, the slot sections 5 of one of the rows 8A overlap the adjacent slot sections 4 of the other row 8B. A certain, but yet very small, overlapping between the slot sections of the different rows may be present before the tearing-off capability becomes deteriorated to a greater extent.

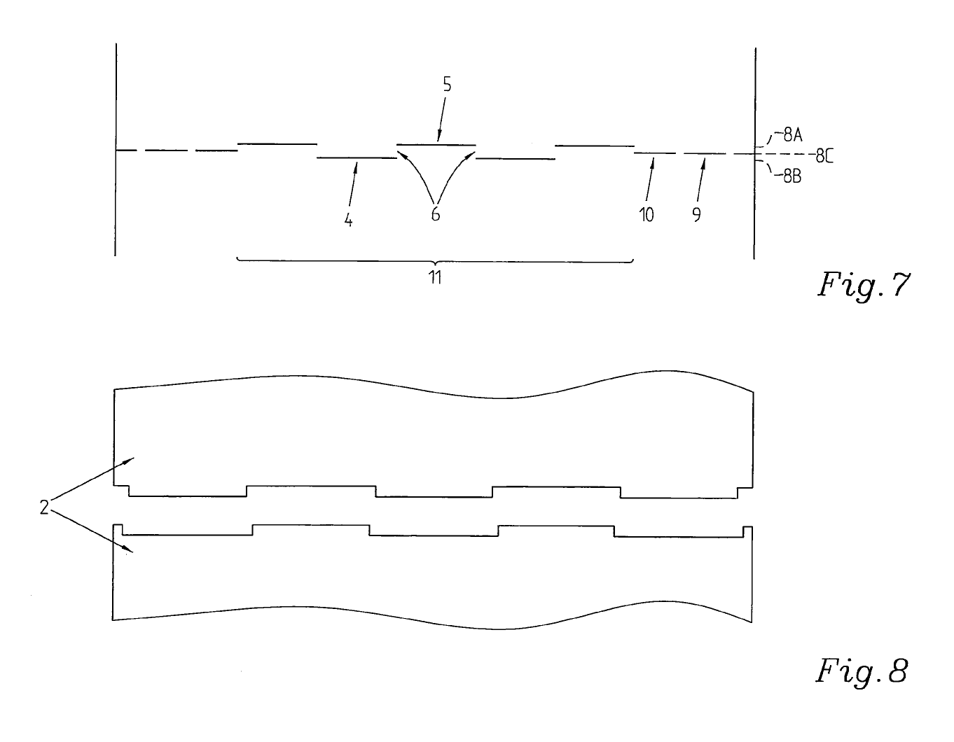

FIG. 7 shows a detailed view of a separation area between two tickets according to an alternative embodiment of the present invention. The design of the central portion 11 is in general identical to the design described in FIG. 1. However, the slot sections 10 arranged closest to the edges 7 are applied on a row, with uniting portions 9 between the slot sections 10 and on the same row as these, along a straight line 8C, instead of alternatingly being located on the rows 8A and 8B, respectively. The straight line 8C may, for instance, be located halfway between the above-mentioned rows 8A, 8B, but may also coincide with some one of said rows 8A, 8B or the like. The idea with this design is that the separation area 3 initially will be subjected to a shear stress in the area 6 of the central portion 11, provided that the tear-off force is applied relatively centrally between the edges 7 of the ticket 2 and in the longitudinal direction y. Then, the tickets 2 will first be separated within said central portion in order to subsequently progress out toward the edges 7. Concurrently with the separation proceeding out toward the edges 7, the effect on the uniting portions 6, 9 will transform from a substantial stress in the longitudinal direction y to a substantial stress in the cross direction x. In this stage of the tearing-off process, therefore, it may facilitate the tearing off if the slot sections 10 are located along the same line 8C in an area closer to the edges 7.

FIG. 8 shows a detailed view of a look of two previously joined tickets 2, according to a preferred embodiment of the present invention, after they have been separated.

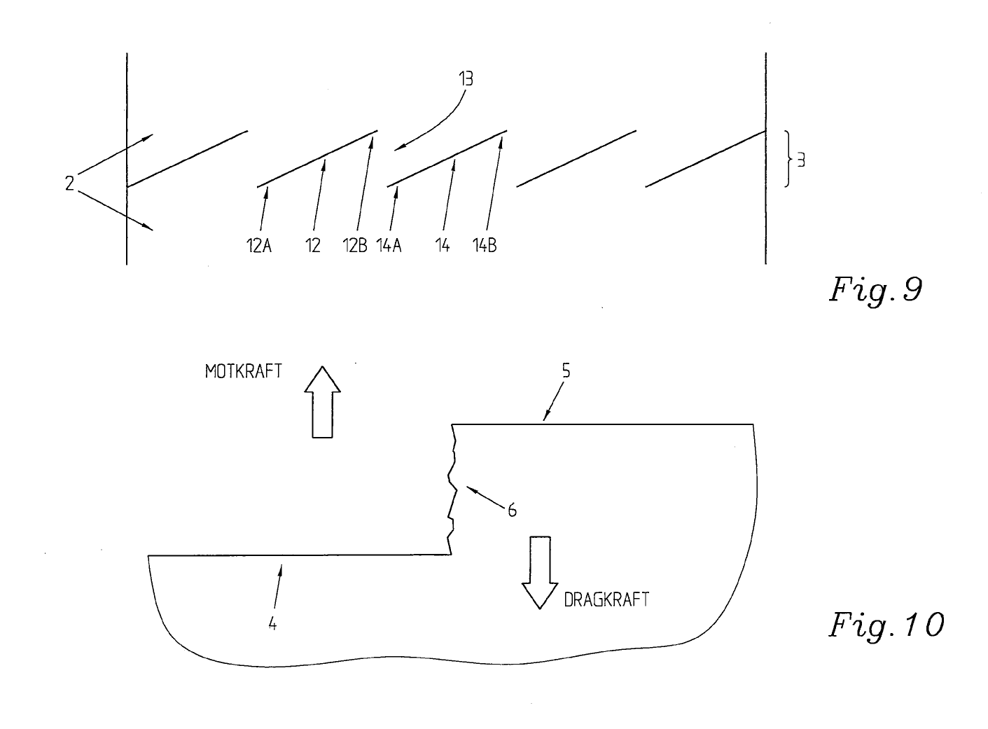

FIG. 9 shows a detailed view of a separation area 3 between two tickets 2 according to another embodiment of the present invention. In the same way as previously, said separation area 3 is composed of a number of separate slot sections 12, 14, where each slot section 12, 14 consists of at least one slot. Upon tearing off, a uniting area 13 will essentially be subjected to a shear stress. The difference in relation to previous embodiments is that the first ends 12A, 14A (the left ones) of the slot sections 12, 14 are arranged on another longitudinal position than the second ends 12B, 14B (the right ones) of the slot sections, at the same time as the cross-direction positions of the first ends 14A are essentially the same as the cross-direction positions of the second ends 12B of the adjacent slot sections. This entails that adjacent tickets 2, before tearing off, essentially are held together by an area 13 situated between adjacent slot sections 12, 14 essentially extending longitudinally. When applying a force in essentially the longitudinal direction y, said areas 13 between adjacent slot sections 12, 14 will substantially be subjected to a shear stress, which will result in a simple and efficient tearing off.

FIG. 10 shows an enlarged view of the look of a torn-off area of a ticket 2 according to one embodiment of the present invention. Thus, the tensile force from a user will be applied in essentially the same direction as the continuous area 6 is arranged. The counter force will act from the ticket machine (not shown), and therefore the continuous area 6 will be subjected to a shear.

FIG. 11 shows a detailed view of an alternative design of a separation area 3 between two tickets 2. The design of the separation area 3 is essentially the same as the design shown in FIGS. 1 and 2. The slot sections 4, 4^{a} and 5 are arranged in parallel rows 8A, 8B with approximately the same distance between the rows, approx. 1 mm. The terminating slot portions 5 are essentially situated in alignment with the slot sections 5. In order to provide a smaller bearing strength in the central portion 11 than close by the edges 7, in a similar way as in the design according to FIG. 4, the slot sections 4^{a} situated closer to the edges 7 are made a bit shorter (in this example 10.6 mm) than the slot sections 4, 5 of the central portion 11 (in this example, these are approx. 11.6 mm). This makes that the beginning and the ending of a slot section 4^{a} will not be situated on the same cross-direction position as adjacent slot sections 5 and the slot portion 5^{b}. In this example, the distance in the cross direction x between the slot sections 5 and the slot sections 4^{a} is approximately 0.25 mm and the distance between the slot section 4^{a} and the slot portion 5^{b} is approximately 0.75 mm, which provides a considerably increased bearing strength close by the edges 7 in comparison with in the central portion 11, since in this example, the tearing off of the area 6 holding together the tickets 2 requires that considerably more paper fibres have to be broken in the areas 6 closer to the edges 7. Accordingly, the distance in the cross direction x between adjacent slot sections is smaller in a central portion 11 of said separation area than in the other part of the separation area. The closer to the edges 7, the greater is the distance between adjacent slot sections.

A similar effect is also attained by making all slot sections of the same length, but that the distance in the cross direction x between the sections becomes greater the closer to the edges. As great a bearing strength in the separation areas 3 as possible is desirable when the web 1 is produced, but as low a bearing strength as possible when the tickets 2 are to be torn off.

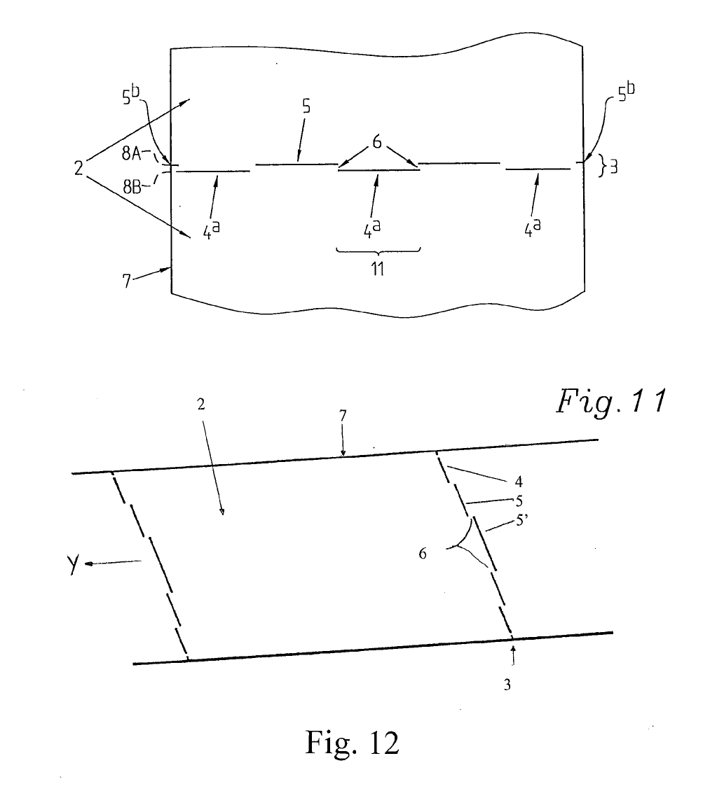

FIG. 12 shows finally a detailed view of an alternative design of a separation area 3 between two tickets 2. In this embodiment, the slot sections 4, 5, 5′ are situated on at least three different longitudinal positions. This entails that the separation area will be subjected to a combined tensile and shear stress when a force is applied in essentially the longitudinal direction y. The uniting areas 6 situated in a central area of a separation area 3 will essentially be subjected to a shear stress, while the areas 6 situated closer to the edges 7 of the separation area 3 will be subjected to a combined tensile and shear stress, and therefore the requisite force required for separating the areas 6 is relatively small.

The web 1 according to application is preferably fed forward mechanically while the tearing off is carried out manually. It is also conceivable that the feed forward may take place manually.

The nature and the function of the invention should have been clear from what has been mentioned above and shown in the drawings, and the invention is naturally not limited to the embodiments described above and shown in the accompanying drawings. Modifications are feasible, the different shown embodiments may be varied and combined without departing from the protection area of the invention, such as it is defined in the claims.

1-10. (canceled)

11. A continuous web of a thin material divided by a plurality of separation areas, which constitute delimitations between tickets, are positioned at a distance from each other in a longitudinal direction of the web and extend in a cross direction between edges of the web, and include a number of separate slot sections substantially extending in the cross direction, the slot sections being situated at a distance in the longitudinal direction in relation to adjacent slot sections within the same separation area so that adjacent tickets, before being torn off, are held together by material areas situated between adjacent slot sections in such a way that the material areas between adjacent slot sections are arranged to be subjected, upon the tearing off, to a shear stress when a force is applied in substantially the longitudinal direction, wherein the longitudinal distance between adjacent slot sections is smaller in a central portion (11) of the separation area than in another portion of the separation area.

12. The web of claim 11, wherein each slot section includes a single slot.

13. The web of claim 11, wherein slot sections in the separation area have different lengths.

14. The web of claim 11, wherein the separation areas include a plurality of rows extending in the cross direction and having separate slot sections.

15. The web of claim 11, wherein the distance in the cross direction between adjacent slot sections is smaller in the central portion of the separation area than in the other portion of the separation area.

16. The web of claim 14, wherein ends of the slot sections in a row begin and end on substantially the same cross-direction positions as corresponding nearest ends of the slot sections in another row end and begin.

17. The web of claim 11, wherein the longitudinal distance between adjacent slot sections is smaller at one side of the central portion of the separation area than at the other side of the central portion.

18. The web of claim 11, wherein the slot sections are between 5 millimeters (mm) and 15 mm long, and the longitudinal distance between adjacent slot sections is between 0.5 mm and 3 mm.

19. The web of claim 11, wherein the web is received on a roll and includes queue tickets collectable in a bin and feedable therefrom for manual tearing off.

20. A continuous web of a thin material divided by a plurality of separation areas, which constitute delimitations between tickets, are positioned at a distance from each other in a longitudinal direction of the web, extend in a cross direction between edges of the web, and include a number of separate slot sections extending substantially in the cross direction, the slot sections being situated at a distance in the longitudinal direction in relation to adjacent slot sections within the same separation area so that adjacent tickets, before being torn off, are held together by material areas situated between adjacent slot sections, wherein the slot sections are situated at least three different longitudinal positions in such a way that at least some of the material areas between adjacent slot sections are arranged to be subjected, upon the tearing off, to a combined tensile and shear stress when a force is applied in substantially the longitudinal direction.
